(19) United States
(12) Patent Application Publication
(10) Pub. No.: US 2003/0162305 A1
(43) Pub. Date: Aug. 28, 2003

(54) Gas contaminant detection and quantification method

(76) Inventors: Daniel Alvarez JR., San Diego, CA (US); Jeffrey J. Spiegelman, San Diego, CA (US)

Correspondence Address: BROWN, MARTIN, HALLER & MCCLAIN LLP, 1660 UNION STREET, SAN DIEGO, CA, 92101-2926, US

(21) Appl. No.: 10/084,022

(22) Filed: Feb. 25, 2002

(51) Int. Cl. G01N 1/22

(52) U.S. Cl. 436/181; 436/139; 436/120; 436/104

(57) ABSTRACT

A method is disclosed for detecting oxidizable contaminants in gas streams at very low levels. A portion of a contaminant-containing gas stream is reacted, preferably catalytically, to effect complete oxidation of the contaminant to at least one oxidized product whose concentration in the system can be readily and quantitatively determined. Since ratio of the contaminant concentration to the product concentration is known, the method provides a simple and effective method of measuring a contaminant concentration which would otherwise be incapable of measurement or capable of measurement only very difficultly. The method is capable of attaining the detection limits required by the most demanding industrial processes of less than 1000 ppt, 500 ppt, or 10 ppt for such contaminants as hydrocarbons, organocarbons and siloxanes. Through rapid quantitative measurements of the oxidized products, contaminant concentration monitoring can operate on substantially a real time basis.

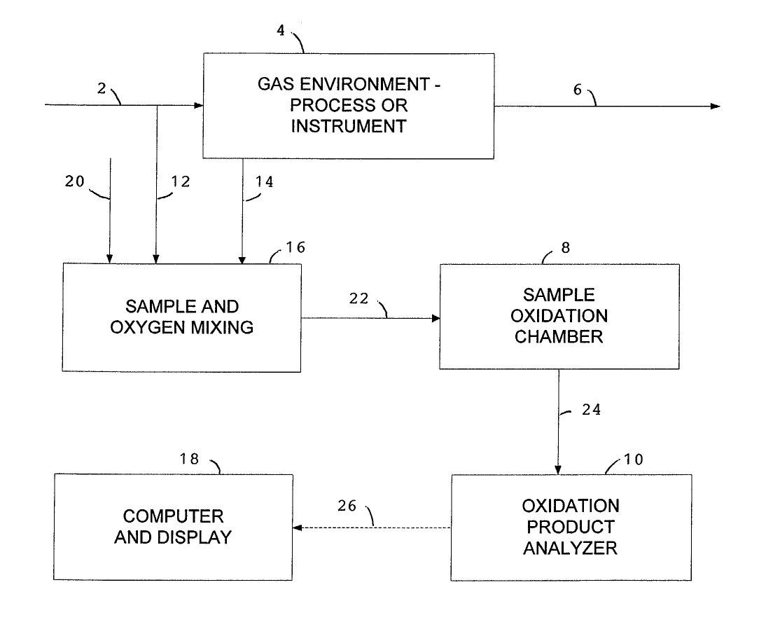

### BACKGROUND OF THE INVENTION

1. Field of the Invention

The invention relates to the quantitative detection of very low levels of oxidizable contaminants in gases. More specifically, the invention discloses a method for enhancing the ability to detect and quantify contaminant in such low levels.

2. Background Information

Hydrocarbons are ubiquitous in the environment. However, many industrial processes cannot tolerate significant hydrocarbon contamination. Particularly notable is the need to avoid hydrocarbon contamination in semiconductor manufacturing and its associated environs and processes, e.g. clean rooms, laser chambers, and photolithography chambers. To avoid such contamination, many methods and devices have been disclosed for the removal of contaminant hydrocarbons from a wide variety of environments.

The effect of gaseous contaminants on photolithography environs and processes has been particularly well studied. Many types of gases are used in photolithography, which are usually contaminated with small amounts of reactive gases or vapors or particulate materials. Molecular contaminants with light absorbances in the UV range reduce the optical transmittance of the lithography tool. Residues, deposits, and condensates form on the optical components of the lithography tool. The photoacids generated by photoresists during the lithography process are sensitive to quenching by molecular contaminants.

A wide variety of different types of decontamination processes and products have been used in the past to produce gases of acceptable levels of purity. U.S. Pat. No. 5,685,895 discloses an apparatus for removing hydrocarbons from the environment of a photolithography tool by contact with an activated carbon chemical filter. U.S. Pat. No. 5,538,545 discloses an apparatus for removing hydrocarbons and other molecular contaminants from clean room environments.

The semiconductor industry has specifically outlined contaminant tolerances in various processes, including the demand of future developments. For example, the Semiconductor Industry Association's “International Technology Roadmap for Semiconductor Technology” outlines current airborne molecular contamination tolerances as less than 5000 parts-per-trillion (ppt). Future developments will require less than 1000 ppt, and probably less than 10 ppt, levels of molecular contaminants.

Molecular contaminants are the cause of many problems in a wide variety of different industries. Carbon-based molecular contaminants are particularly harmful to energetic processes, as they often result in carbidization on surfaces and absorptive energy loss. Carbidization is particularly detrimental to optical processes—e.g. lasers or photolithography tools, wherein carbon deposits can render a lens or entire device useless.

In order to monitor the contamination in a particular process, it is necessary to be able to detect contaminants in concentrations which are less than or equal to the concentration tolerance threshold for the contaminant in the process. Current technology for real time online monitoring of hydrocarbon content in gaseous environments is capable of reaching only 3000 ppt, using flame ionization detection (FID). However, it is desirable to be able to detect less than 1000 ppt, preferably less than 500 ppt, and more preferably less than 10 ppt, hydrocarbon content. Presently this can only be accomplished by complicated and time-consuming means. The most sensitive current means for detecting low levels of hydrocarbon contamination requires concentrating the hydrocarbon content with a desorption tube containing a hydrocarbon-sorbing material. Desorption and analysis of the concentrated hydrocarbon sample then allows for extrapolation to the original hydrocarbon levels. The devices used to obtain these results are generally large, bulky, and non-portable instruments. Additionally, the analyte must be concentrated over many hours and the analysis of the concentrated sample may take several more hours.

Materials for catalytic oxidation have been aggressively developed in recent years, mainly for use in hydrocarbon abatement systems, e.g. automotive exhaust, and in catalytic combustion systems, e.g. power generation. For low temperature catalytic oxidation of hydrocarbons, the most effective catalysts have proven to be Pd, Rh, or Pt supported on oxygen-rich inorganic materials, e.g. zirconia, ceria, or tin oxide. These materials lower the temperature required for total hydrocarbon and/or organocarbon oxidation from greater than 1000° C. to about 150-400° C. One example of a commercially available material is 5% palladium on zirconia from Johnson Matthey Corp.

### SUMMARY OF THE INVENTION

The invention disclosed herein provides a method for readily detecting and quantifying oxidizable contaminants in gas streams at very low levels, which has heretofore been very difficult or impossible in a timely manner, but is becoming necessary in certain industries. This method overcomes the limitations of concentration methods and can thus be applied to direct, continuous, and immediate monitoring of processes wherein gas contamination is critical. The method involves oxidizing a contaminant-containing gas stream, preferably by catalytic oxidation, under conditions sufficient to effect complete catalytic oxidation of the contaminant to one or more oxidized products whose concentration in the system can be readily and quantitatively determined. Since the oxidation products are more easily detected than the contaminants, as a result of greater sensitivity of equipment and/or higher concentration, and the ratio of the contaminant concentration to the product concentration is known, the method provides a simple and effective method of measuring a contaminant concentration which would otherwise be incapable of measurement or capable of measurement only very difficultly. One can characterize the method as being one which in effect “chemically amplifies the concentration signal” of the contaminant through the proxy of its oxidative product(s). The method is capable of attaining the detection limits required by the most demanding industrial processes of less than 1000 ppt, preferably less than 500 ppt, and more preferably less than 10 ppt. for typical contaminants, which are most commonly hydrocarbons, organocarbons, and/or siloxanes. Further, since the preferred detectors for oxidative reaction products will be ones which achieve rapid quantitative measurements, contaminant concentration monitors can often be conducted on an on-going, real time basis.

Oxidizable contaminants which are of particular interest for detection in this invention include, but are not limited to, those hydrocarbons, siloxanes, organosilanes, organosulfides, organophosphides and organohalides which are difficult or time-consuming to detect directly at the desired low contamination levels and which can be oxidized to more readily and quickly detected oxidized products.

As an example, consider measurement of 2500 ppt hydrocarbon contamination by this “signal amplification” method, in which one uses quantitative catalytic oxidation of a hydrocarbon to an oxidation product that has a lower detection limit and/or a higher concentration. As noted above, that level of hydrocarbon contamination is only determinable at present with great difficulty by a process requiring many hours duration. However, the two products of complete oxidation of a hydrocarbon are carbon dioxide and water. The oxidation reaction yields these oxidation products in a higher concentration than the original contaminant:

CₓH_{y}+(2x+½y)O→xCO₂+½yH₂O [1]

Additionally, the oxidized products are readily capable of detection at substantially lower concentration limits than is the original hydrocarbon contaminant. Consider pentane (C₅H₁₂, detection limit=3000 ppt) as the contaminant. Oxidation of one molecule of pentane yields five molecules of carbon dioxide (CO₂, detection limit=1000 ppt) and six molecules of water (H₂O, detection limit=200 ppt). Therefore, by detecting the oxidation products from this simple hydrocarbon, one obtains 15-90-fold signal amplification, making it possible to detect pentane at a level as low as about 40 ppt. As a second example, consider decane (C₁₀H₂₂, detection limit=3000 ppt) as the contaminant. Oxidation of one molecule of decane yields ten molecules of carbon dioxide (CO₂, detection limit=1000 ppt) and eleven molecules of water (H₂O, detection limit=200 ppt). Therefore, by detecting the oxidation products from this heavier hydrocarbon, one obtains 30-165-fold signal amplification, making it possible to detect decane at a level as low as about 20 ppt. In addition, equipment and systems are readily available to detect CO₂ and water at their detection limits on a real time basis. Consequently by oxidizing the hydrocarbon contaminant and using its oxidation products, CO₂ and water, as proxies, one can quantitatively measure the concentration of the contaminant itself at levels far below that at which it can be detected and measured directly.

In the above chemical reaction the oxygen is not limited to molecular oxygen, rather it is depicted as elemental oxygen to denote that many oxygen sources are possible. Oxygen gas (O₂) may be present in the gas or mixed into stream prior to contact with the catalyst. However, another readily available source of oxygen, such as air (preferably purified air). Another source of oxygen is the oxygen adsorbed on the catalyst material when oxygen-rich substrates are used.

In detecting hydrocarbon and organocarbon contamination the desired quantity is often total carbon content, because carbidization is often the principal contamination mechanism. When carbidization occurs on surfaces in energetic processes, all of the carbon present is converted into carbide deposits. However, when absorptive contamination is a greater concern, determination of the relative amounts of certain classes of contaminants may be desired. The method of this invention may be used to extract this information by varying the temperature at which the catalytic oxidation occurs. For example, the same catalyst is capable of completely converting carbon monoxide to carbon dioxide at 150° C., methane (CH₄) to carbon dioxide at 350° C., and C₂-C₆ non-methane light hydrocarbons to carbon dioxide at 200° C., so selective fractions of the contaminant mixture can be individually oxidized and their concentration measurements isolated. Similarly, the non-methane light hydrocarbons and carbon monoxide from atmospheric contamination can be isolated from heavy hydrocarbon (>C₇) contamination from off gassing of plastic components. The ability of this method to provide for identification of the concentration of certain classes of contaminants will be of great advantage to process operators who can thus focus on different sources of contamination for selective remediation.

The present method may be performed as a function of a larger system or may itself be the function of a separate instrument. The oxidation catalyst material may be retained in any convenient form, such as in a canister, in a diffuser or on a surface. The means for the product analysis may be any appropriate analytical instrument, a number of which are well known in the art, e.g. infrared, FID, or electronic. If desired the device may be made portable to be transported on a cart or by hand.

### BRIEF DESCRIPTION OF THE DRAWING

The single FIGURE of the drawing is a diagram of a typical experimental arrangement for performing the method of this invention, in which a sample of a contaminated gas stream is extracted and subjected to quantitative catalytic oxidation with one or more catalysis oxidation products then analyzed, from which analysis the concentration of the contaminant in the gas stream is determined.

### DETAILED DESCRIPTION AND PREFERRED EMBODIMENTS

The invention provides a method for determining the concentration of an oxidizable contaminant or contaminants present in a gas stream when those concentrations are too low to be readily determined directly. This is accomplished by complete oxidation of a sample of the contaminated gas stream to convert the contaminants to oxidized products which are more easily detectable and/or present in a higher concentration than the original contaminants. Catalytic oxidation is preferred, since it is normally easy to accomplish under controlled conditions, but other oxidizing reactions, such as non-catalytic thermal oxidation, may also be used. This method allows for the detection of oxidizable gas contaminants at previously unattainable concentration levels, such as hydrocarbon contaminant levels of less than 1000 ppt, preferably less than 100 ppt, and more preferably less than 10 ppt.

In this method, a gas stream is routed through a conduit 2 to a process, instrument or other device or system 4 in which the gas comprises a reactant or forms an environment in or around the device or system 4. After the system reaction or after the environmental function is complete, exhaust gas is vented from the device or system 4 through a conduit 6. The nature of the device or system 4 and the use of the gas in connection with that device or system is not significant to this invention. Rather the significant aspects are that a) the gas stream or the gas within the device or system 4 is known or believed to contain one or more oxidizable contaminants, which are gaseous or vaporous, and b) that the concentrations of such contaminants in the gas stream or in the device or system environment are at concentrations which are too low to be measured accurately by prior art means, or, even if measurable, can only be measured by such prior art means in a manner which is difficult or required an unreasonable amount of time to complete or both.

The present invention overcomes such difficulties and provides accurate low level contaminant concentration information in a timely and readily accomplished manner. Specifically the method involves extraction of an analysis sample of the contaminant-containing gas present in or being routed to an instrument, operation environment, or process chamber 4, either through conduit 12 or 14, optionally mixing with oxygen gas in a mixer 16, followed by routing of the oxygen/sample through conduit 22 for contact with an oxidation catalyst in a sample oxidation chamber 8 to effect complete oxidation. The effluent of the oxidation reaction is routed from chamber 8 through conduit 24 for the analysis and identification of the oxidation products in an analyzer 10. The oxidation catalyst in the oxidation chamber 8 is generally held at a temperature above 100° C. and below the temperature of spontaneous combustion of the sample, generally <1000° C., by use of heaters 28, The specific oxidation temperature will vary according to the catalyst used and the contaminant being analyzed. The temperature necessary for a given application will be known to or may be readily determined by those skilled in the art. The results of the analysis in analyzer 10 are then transmitted to the computer 18 as indicated by line 26. The computer 18 converts the oxidation product analysis of the analyzer 10 to the value of the concentration of the original contaminant and displays that value in any convenient manner.

A number of suitable oxidation catalysts are available in the literature, and the specific catalyst used is important to the method only to the extent that it must effect complete oxidation of the contaminant within a reasonable time period. Preferably that time period will be quite short, such that the overall catalysis/analysis/reporting method can be quickly completed. This will allow the system operator to obtain a determination of the concentration of the contaminant in close to a real time mode, such that system adjustments can be made in a timely manner and any detrimental effects of the contaminated gas stream on the system (e.g., damage to semiconductor chips) can be minimized and remedied quickly. Catalysts suitable for the method include, but are not limited to, materials such a transition metals (e.g., Pd, Pt, or Rh) or lanthanide metals supported on oxygen-rich inorganic substrates (e.g. zirconia, ceria, or alumina), or combinations thereof. Additionally, the catalyst can be in any suitable form, including but not limited to as an alloy, impregnated support, and other solid solution. The choice of catalyst will be determined by the contaminant or contaminants being analyzed and the desired operating conditions (e.g., temperature, pressure, flow rate).

For complete oxidation, at least the stoichiometric ratio of oxygen to the contaminant is required. Various alternatives for provision of this oxygen are possible. The oxygen may be present in sufficient quantity in the gas stream, in which case the separate mixer 16 may be omitted and the sample passed directly to the oxidation chamber 8 through a conduit equivalent to 12/22 or 14/22. Alternatively, if there is no oxygen in the gas stream, or if it is present in insufficient concentration for complete oxidation of the sample in chamber 8, total or makeup quantities of oxygen may be externally provided through line 20 for mixture with the gas sample in mixer 16. Mixer 16 may also be omitted if oxygen is supplied directly to the oxidation chamber 16, as through a conduit equivalent to 20/22. It is possible to add oxygen directly to the gas stream as pure oxygen or gas mixtures containing oxygen, including air, but that will only be under conditions where the oxygen or air will not itself be a contaminant or added burden in the gas stream. Oxygen adsorbed on the catalyst material, especially on the aforementioned oxygen-rich catalysts, is the most active source of oxygen and may be sufficient to effect complete oxidation, dependent upon the contaminant or contaminants being oxidized and the operating conditions (e.g. temperature, pressure, flow rate).

A heat exchanger (not shown) may be placed in conduit 24 if desired, to cool the effluent from the oxidation chamber 8 to a stable temperature for analysis. This step is optional but will be preferred if the analyzer 10 being used is temperature sensitive. Suitable heat exchange devices are well known, and commonly used examples feature gas flowing through a monoblock fitted with fins to increase the surface area for heat radiation and/or a compartment separate from the gas flow through which a cooling liquid is flowed. The outlet temperature of the heat exchanger may vary according to the type and properties of the analytical device. If the analytical device is not temperature sensitive and/or is capable of analyzing the components of the gas directly from the catalytic oxidation chamber, this step is not necessary.

Within the analyzer 10 the effluent of the oxidation chamber 8 enters a compartment in which it is analyzed for the oxidation products of the catalytic oxidation step. The analytical device 10 may be any device capable of detecting low levels of the oxidized species in a gas stream. Examples utilizing detection of CO₂ include infrared and Raman-based spectrometers, flame-ionization detectors, methanizers, electronic devices and mass-based spectrometers, while examples using detection of water include laser spectrometry, electrochemical sensors, piezoelectric sensors and capacitance-based devices. The specific device will be readily selected by a system operator based on the contaminant or contaminants being analyzed and the operating conditions (e.g. temperature, pressure, flow rate).

The computer 18 may be a separate device or it may be combined in a single unit with the analyzer 10. Alternatively the computer 18 may be separate from the analyzer but be a larger computer which performs many other tasks as well as operating in this method. (For simplicity of description herein the computer 16 will be considered as a single-purpose device separate from the analyzer 10, and the analyzer 10 will be considered to perform only an effluent analysis function.) The computer 18 will primarily provide information to determine if the gas stream or environment of the device or system 4 is within acceptable contaminant limits. The data obtained from the analytical device 10 is analyzed according to the chemical relationship between the contaminant or contaminants and the oxidized species, which relationship will be pre-programmed into the computer. One example, which illustrates this relationship, is the complete oxidation of hydrocarbons. The oxidation of hydrocarbons follows equation 1 above. Thus, if one detects the concentration of carbon dioxide after complete oxidation of all hydrocarbon material, one immediately obtains an initial total carbon content value. This value is relevant to the amount of carbidization that could occur in the process. If one also considers the temperature of the catalyst, one can distinguish between total carbon content for light hydrocarbons (C₁-C₆) and heavy hydrocarbons (C₇-C₂₀). Additionally, one can adjust the temperature for a given catalyst to selectively oxidize carbon monoxide in the presence of other hydrocarbons. Thus, one may obtain a value for carbon monoxide concentration by detecting the amount of carbon dioxide in the effluent which is produced in accordance with equation 2:

CO+½O₂→CO₂ [2]

Alternatively, or additionally, one may analyze the water concentration in the effluent, which will be one-half the total hydrogen content of the hydrocarbons. If the hydrocarbon contaminant or contaminants being oxidized are known, this value may be used to extrapolate to the original hydrocarbon concentration. However, if the hydrocarbon contaminant or contaminants being oxidized are not known, this value may be used in combination with the total carbon content to obtain a molecular saturation ratio. This saturation ratio is calculated from equation 3:

$$\frac{( atoms of hydrogen per molecule ) - 2}{2 \times ( atoms of carbon per molecule )} = Saturation ratio \qquad [ 3 ]$$

The saturation ratio will vary from 1 for completely saturated hydrocarbons, with the formula CₓH₂ₓ₊₂, to 0 for the most unsaturated small molecule, acetylene (C₂H₂). While it is hypothetically possible to obtain a negative number for the saturation ratio, compounds that meet these criteria, e.g. graphitic materials, are not known to exist in the gas phase under normal conditions. The saturation ratio provides an approximate degree of saturation for the hydrocarbons being oxidized. Similar analyses may be performed for other oxidizable contaminants, e.g. siloxanes.

The specific embodiment of equipment selected to perform the present method is not critical. However, one preferred embodiment of the present invention is a portable device capable of online, immediate, and direct monitoring of contaminant levels below the current detection limits. In such an embodiment the computer 18, oxidation chamber 8 and analyzer would be small in size, possibly combined in a single housing, and capable of being contained on a small cart or possibly carried by hand.

It will be evident that there are numerous embodiments of the present invention which are not expressly described above but which are clearly within the scope and spirit of the present invention. Therefore, the above description is intended to be exemplary only, and the actual scope of the invention is to be determined from the appended claims.

We claim:

1. A method for detecting and quantifying an oxidizable contaminant in a gas stream at a low concentration level which comprises:
a. subjecting at least a portion of said gas stream to an oxidation reaction under conditions sufficient to effect complete oxidation of said contaminant to an oxidized product whose presence is more readily detected and quantified than is said contaminant at said low concentration level;
b. determining the quantity of said oxidized product in said portion after said complete oxidation; and
c. determining from said quantity of oxidized product the concentration of said oxidizable contaminant in said portion from the stoichiometry of the oxidation reaction.

2. A method as in claim 1 wherein said oxidizable contaminant is selected from the group consisting of hydrocarbons, siloxanes, organosilanes, organosulfides, organophosphides and organohalides.

3. A method as in claim 2 wherein concentration of said oxidizable contaminant is reduced to less than 1000 ppt.

4. A method as in claim 3 wherein concentration of said oxidizable contaminant is reduced to less than 500 ppt.

5. A method as in claim 4 wherein concentration of said oxidizable contaminant is reduced to less than 100 ppt.

6. A method as in claim 5 wherein concentration of said oxidizable contaminant is reduced to less than 10 ppt.

7. A method as in claim 1 wherein said subjecting comprises contacting said portion to contact with an oxidation catalyst under conditions sufficient to effect complete catalytic oxidation of said contaminant to an oxidized product.

8. A method as in claim 7 wherein said oxidation catalyst comprises a transition metal or lanthanide metal or combinations thereof.

9. A method as in claim 7 wherein said oxidation catalyst is supported on an oxygen-rich inorganic substrate or present as an alloy or solid solution.

10. A method as in claim 9 wherein said substrate comprises zirconia, ceria, or alumina.

11. A method as in claim 1 wherein said oxidation product has a higher concentration in said portion after oxidation than did said contaminant prior to oxidation.

12. A method as in claim 1 wherein said oxidation product is effectively detectable and quantifiable at lower concentrations in said portion than is said contaminant.

13. A method as in claim 1 wherein sufficient oxygen for said complete oxidation comprises oxygen or air which is present in said portion of said gas stream.

14. A method as in claim 1 wherein said portion of said gas stream contains insufficient oxygen for said complete oxidation and said method further comprises adding free oxygen or air to said portion prior to said complete oxidation.

15. A method as in claim 1 wherein said contaminant comprises a hydrocarbon at a concentration of less than 3000 ppt and said oxidation product comprises at least one of water or carbon dioxide.

16. A method as in claim 1 further comprising a plurality of oxidizable contaminants in said gas stream.

17. A method as in claim 16 further comprising selectively quantifying concentrations of contaminants within said plurality by controlling conditions of said oxidation such that less than all of said plurality of said contaminants are completely oxidized.

18. A method as in claim 17 wherein said oxidation is by contact of said portion with an oxidation catalyst and controlling conditions comprises maintaining temperature at which said contact occurs within a temperature range at which less than all of said plurality of contaminants are catalytically oxidized.

19. A method as in claim 1 wherein said contaminant comprises a hydrocarbon of unknown identity and said method further comprises determining the saturation ratio of said hydrocarbon from analysis of the oxidized product, such that identity of said hydrocarbon may thereafter be determined.

20. A method as in claim 1 wherein said steps a., b. and c. are accomplished by means embodied in a compact transportable system.
